(19) United States
(12) Patent Application Publication
(10) Pub. No.: US 2014/0232846 A1
(43) Pub. Date: Aug. 21, 2014

(54) IMAGE ACQUISITION APPARATUS AND IMAGE ACQUISITION SYSTEM

(71) Applicant: CANON KABUSHIKI KAISHA, Tokyo (JP)

(72) Inventor: Kazumasa Tanaka, Utsunomiya-shi (JP)

(73) Assignee: CANON KABUSHIKI KAISHA, Tokyo (JP)

(21) Appl. No.: 14/184,519

(22) Filed: Feb. 19, 2014

(30) Foreign Application Priority Data
Feb. 21, 2013 (JP) 2013-032104

(51) Int. Cl. G02B 21/36

(52) U.S. Cl. CPC G02B 21/361; G02B 21/365
USPC 348/79

(57) ABSTRACT

An image acquisition apparatus includes an imaging optical system configured to form an image of an object, a re-imaging optical system configured to re-form the image of the object formed by the imaging optical system, a reflecting member arranged on an optical path between the imaging optical system and the re-imaging optical system, an image sensor configured to capture the image of the object re-formed by the re-imaging optical system to output image data, a first driving unit configured to change a tilt of the reflecting member with respect to an optical axis of the imaging optical system, a control unit configured to control the first driving unit according to a shape of the object, and a correction unit configured to correct a positional displacement of the image in an in-plane direction according to the change in the tilt of the reflecting member.

### BACKGROUND OF THE INVENTION

1. Field of the Invention

The present invention relates to an image acquisition apparatus, and is suitable for an image acquisition system for acquiring image data of a pathological specimen, for example.

2. Description of the Related Art

In a recent pathological diagnosis, attention has been drawn to an image acquisition system in which an image acquisition apparatus captures an image of a pathological specimen (sample) to acquire image data and displays the image data on a display for observation. Use of the image acquisition system allows a plurality of persons to simultaneously observe the image data of the sample and allows the image data to be shared with a pathologist who is distant from there.

When the image acquisition apparatus is used to observe a large sample that cannot be contained in the field of view of an objective lens, the image acquisition apparatus can acquire an image of the entire sample by horizontally moving the sample and capturing images a plurality of times (step imaging) or by capturing an image while scanning the sample. Further, observation of the sample requires an objective optical system having a high resolution in a visible light range. However, an increase of a numerical aperture (NA) of the objective optical system to acquire a high resolution causes the depth of focus to be shallow, and if there is unevenness on the surface of the sample in the depth direction, a part of the sample is put out of focus, resulting in incapability to acquire a good image of the entire sample.

Japanese Patent Application Laid-Open No. 2007-208775 discusses an imaging apparatus capable of correcting the curvature of field of a photographic lens by deforming an imaging plane. The imaging apparatus drives each of a plurality of photoelectric conversion elements to deform the imaging plane according to the curvature of field. U.S. patent application Ser. No. 08/772,977 (U.S. Pat. No. 5,777,719) discusses an apparatus capable of correcting the distortion of a wavefront by using a deformable mirror. The apparatus deforms the mirror based on measurement data of wave aberration of an eye to correct the aberration.

In the imaging apparatus discussed in Japanese Patent Application Laid-Open No. 2007-208775, each of the plurality of the photoelectric conversion elements needs to be provided with an electric circuit for reading data, a driving unit for driving the photoelectric conversion element, and a cooling mechanism for cooling the photoelectric conversion element. However, in order to adjust focus according to the unevenness on the surface of the sample, the imaging plane needs to be deformed more significantly. Accordingly, providing each of the plurality of the photoelectric conversion elements with the driving unit for focus adjustment and the cooling mechanism in the imaging apparatus makes the apparatus complicated (upsized). The apparatus discussed in U.S. patent application Ser. No. 08/772,977 includes the mechanism for correcting the distortion of the wavefront. However, the correction is performed in a pupil position of the optical system, so that it is impossible to apply such a mechanism to the image acquisition apparatus without change so as to correct defocusing due to the unevenness on the surface of the sample.

### SUMMARY OF THE INVENTION

The present invention is directed to an image acquisition apparatus capable of acquiring good image data of an entire sample by using a simple configuration even if there is unevenness on the surface of the sample in the depth direction.

According to an aspect of the present invention, an image acquisition apparatus includes an imaging optical system configured to form an image of an object, a re-imaging optical system configured to re-form the image of the object formed by the imaging optical system, a reflecting member arranged on an optical path between the imaging optical system and the re-imaging optical system, an image sensor configured to capture the image of the object re-formed by the re-imaging optical system to output image data, a first driving unit configured to change a tilt of the reflecting member with respect to an optical axis of the imaging optical system, a control unit configured to control the first driving unit according to a shape of the object, and a correction unit configured to correct a positional displacement of the image in an in-plane direction according to the change in the tilt of the reflecting member.

Further features of the present invention will become apparent from the following description of exemplary embodiments with reference to the attached drawings.

### BRIEF DESCRIPTION OF THE DRAWINGS

FIG. 1 is a schematic diagram illustrating main portions of an image acquisition system according to an exemplary embodiment of the present invention.

FIGS. 2A and 2B are diagrams illustrating a focus adjustment method performed by a reflecting member according to the present exemplary embodiment.

FIG. 3 is a schematic diagram illustrating main portions of a reflecting member driving unit according to the present exemplary embodiment.

FIG. 4 is a schematic diagram illustrating main portions of an image sensor driving unit according to the present exemplary embodiment.

FIGS. 5A, 5B, and 5C respectively illustrate an approximate plane of surface of a sample in an imaging area.

FIG. 6 illustrates an imaging area and an approximate plane corresponding to each step.

FIGS. 7A and 7B illustrate the approximate plane of the surface of the sample, and a displacement of the image of the sample.

FIGS. 8A and 8B are schematic diagrams illustrating main portions of an objective optical system and its periphery according to a first exemplary embodiment of the present invention.

FIGS. 9A and 9B are schematic diagrams illustrating main portions of an objective optical system and its periphery according to a second exemplary embodiment of the present invention.

### DESCRIPTION OF THE EMBODIMENTS

Various exemplary embodiments, features, and aspects of the invention will be described in detail below with reference to the drawings.

The same components are given the same reference numerals in each figure and the duplicate description thereof is omitted.

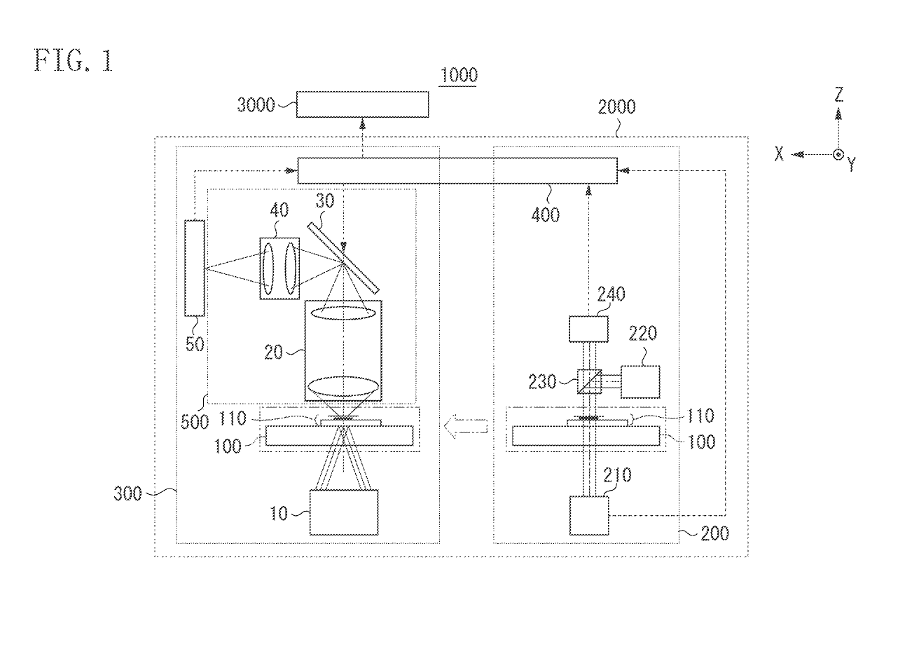

FIG. 1 is a schematic diagram illustrating main portions of an image acquisition system 1000 according to an exemplary embodiment of the present invention. The image acquisition system 1000 includes an image acquisition apparatus 2000 serving as a microscope for acquiring an image of a sample, and an image display unit 3000 for displaying the acquired image. The image acquisition apparatus 2000 includes a stage 100 for holding a preparation 110 including a sample, a measurement unit 200 for acquiring information about the sample, an imaging unit 300 for capturing an image of the sample, and a calculation unit 400 for controlling the measurement unit 200 and the imaging unit 300 and for processing the captured image.

The measurement unit 200 includes a position measurement sensor 210, a measurement light source 220, a beam splitter 230, and a shape measurement sensor 240. The imaging unit 300 is provided with an illumination optical system 10, an objective optical system 500 including an imaging optical system 20, a reflecting member (reflection mirror) 30, and a re-imaging optical system 40, and an image sensor 50. As illustrated in FIG. 1, a stage 100 is movable between the measurement position of the measurement unit 200 and the imaging position of the imaging unit 300.

A procedure for acquiring an image by the image acquisition apparatus 2000 according to the present exemplary embodiment will be described below. In the present exemplary embodiment, the optical axis direction of the imaging optical system 20 is taken as the Z direction, the direction perpendicular to the surface of paper is taken as the Y direction, and the direction perpendicular to the Z and Y directions (the optical axis direction of the re-imaging optical system 40) is taken as the X direction.

First, the preparation 110 including a sample is arranged on the stage 100. The stage 100 is moved to the measurement position of the measurement unit 200 while holding the preparation 110. In the measurement unit 200, a light flux from a measurement light source 220 is deflected by a beam splitter 230 to irradiate the preparation 110. The light flux that has passed through the preparation 110 is incident on the position measurement sensor 210 which acquires information about the size of the sample and the position thereof in the X and Y directions in the preparation 110. A commercially available charge-coupled device (CCD) camera may be used as the position measurement sensor 210.

On the other hand, the light flux reflected on the preparation 110 passes through the beam splitter 230 and is incident on the shape measurement sensor 240. The shape measurement sensor 240 measures position information in the Z direction in each of the X and Y directions of the sample surface in the preparation 110 to acquire information about the shape of the sample. A commercially available Shack Hartman Sensor, an interferometer, or a line sensor, for example, may be used as the shape measurement sensor 240. The configuration of the measurement unit 200 is not limited to the above. For example, the measurement of position and size of the sample and the measurement of surface shape of the sample may be performed at a different position by using a different light source.

The sample information (position, size, and shape of the sample) acquired by the measurement unit 200 is transmitted to the calculation unit 400 and stored in a memory of the calculation unit 400. After the measurement unit 200 finishes acquiring the sample information, the stage 100 holding the preparation 110 is moved from the measurement position of the measurement unit 200 to the imaging position of the imaging unit 300.

In the imaging unit 300, the preparation 110 is uniformly illuminated by the light flux emitted by the illumination optical system 10. As the light flux emitted by the illumination optical system 10, visible light with a wavelength of 400 nm to 700 nm may be used, for example. The imaging optical system 20 causes the light flux that has passed through the sample in the preparation 110 to form an image of the sample near the reflecting member 30. The light flux forming the image of the sample is reflected on the reflecting member 30, deflected outside the optical path of the imaging optical system 20, and converged on the imaging plane of the image sensor 50 by the re-imaging optical system 40, so that the image of the sample is formed again. The imaging optical system 20 and the re-imaging optical system 40 according to the present exemplary embodiment are a double telecentric optical system.

The tilt of the reflecting member 30 with respect to the optical axis of the imaging optical system 20 can be changed and controlled by the calculation unit 400 according to the information about the shape of the sample. The image sensor 50 can be moved to the direction perpendicular to the direction of the optical axis of the re-imaging optical system 40. The direction and amount of movement thereof are controlled by the calculation unit 400 to correct a positional displacement of the image in the in-plane direction according to the change in the tilt of the reflecting member 30. A commercially available rotation mechanism or translation mechanism may be used as the driving units of the reflecting member 30 and the image sensor 50. The imaging unit 300 adjusts the tilt of the reflecting member 30 and the position of the image sensor 50 in the in-plane direction to allow acquisition of good image data in which the entire sample is in focus (to be described in detail below).

The imaging optical system 20 may cause a light flux to form an image of the sample not only once but also a plurality of times. For example, a system for forming an intermediate image such as a reflection refraction optical system may be used in the process of forming an image of the sample near the reflecting member 30. In other words, in the objective optical system 500 according to the present exemplary embodiment, the imaging optical system 20 has only to cause the light flux from the sample to eventually form the image thereof near the reflecting member 30, and thus the number of times of forming an image is optional. Further, it is desirable that the re-imaging optical system 40 is a magnification system which magnifies the image of the sample formed by the imaging optical system 20 at a predetermined lateral magnification and re-forms the image.

The image sensor 50 captures the image of the sample re-formed on the image plane, and the calculation unit 400 processes the information output from the image sensor 50 to generate image data. In order to acquire the entire image of the sample, a plurality of pieces of image data is acquired by capturing images a plurality of times while horizontally moving the stage 100 (step imaging) or by capturing an image while scanning. Then, the calculation unit 400 puts the plurality of pieces of image data together to allow one image data to be generated. The calculation unit 400 performs not only the above processing but also various processing according to the application, such as correcting the aberration which the objective optical system 500 has failed to correct. The image data acquired by the imaging unit 300 can be displayed on the image display unit 3000.

Although the sample information is acquired by the measurement unit 200 in the present exemplary embodiment, the image acquisition apparatus 2000 does not necessarily need to include the measurement unit 200. For example, the sample information acquired by an external apparatus may be transmitted to the calculation unit 400. In this case, the imaging unit 300 and the calculation unit 400 may form a microscope apparatus. As described above, the calculation unit 400 serves as both a control unit for controlling the measurement unit 200 and the imaging unit 300, and an image processing unit for processing a captured image. However, the image acquisition apparatus 2000 may be separately provided with the control unit and the image processing unit.

A focus adjustment method using the reflecting member 30 to change an image-forming position of the imaging optical system 20 will be described below.

If a sample has a wave shape (unevenness in the Z direction) when the image acquisition apparatus 2000 acquires an image of the sample, the position where the imaging optical system 20 forms an image of each area of the sample (the image-forming position) changes according to the XY position of the sample. In other words, a flat image plane of the sample cannot be formed by the imaging optical system 20. Even if the image sensor 50 is arranged on a flat surface near the image plane of the sample, an image in which the entire sample is in focus cannot be acquired.

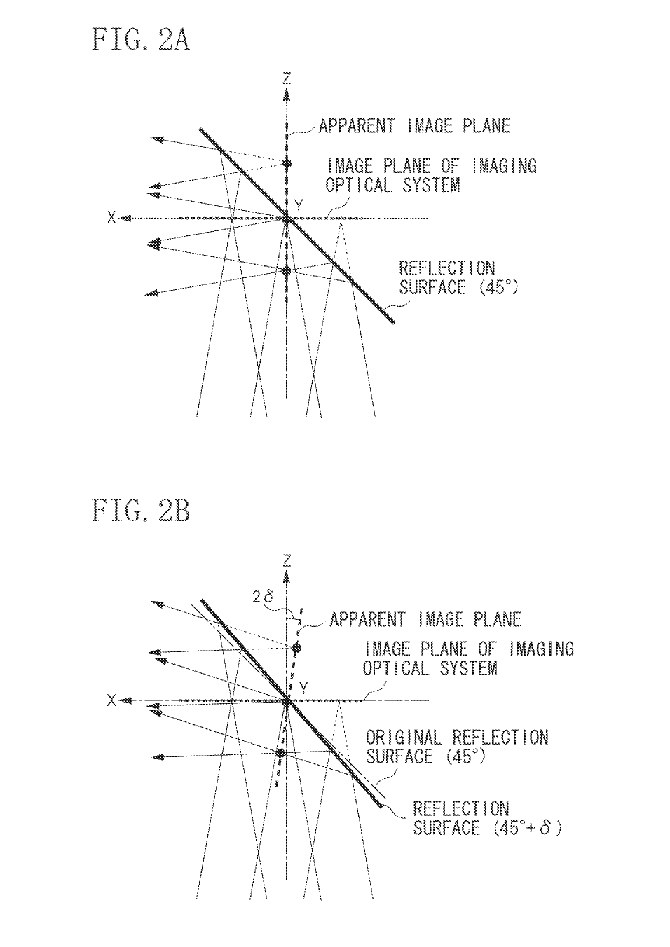

Thus, adjustment of an image-forming position of the light flux from the imaging optical system 20 by changing the tilt of the reflecting member 30 will be discussed. FIGS. 2A and 2B are schematic diagrams illustrating a positional relationship between the position of the image plane made by a plurality of image-forming points of the imaging optical system 20 and the reflection surface of the reflecting member 30. Here, a case will be discussed in which the tilt of the reflecting member 30 is changed with an optical axis Y, which is orthogonal to an optical axis Z of the imaging optical system 20 and an optical axis X of the re-imaging optical system 40, as a rotational axis. As illustrated in FIG. 2A, if the reflection surface of the reflecting member 30 is arranged to be tilted by 45 degrees with respect to the optical axis Z of the imaging optical system 20, the image plane of the imaging optical system 20 is rotated 90 degrees by the reflecting member 30 to form an apparent image plane. Further, as illustrated in FIG. 2B, if the tilt of the reflection surface is changed by an angle 6 with the axis Y as the rotational axis, the tilt of the apparent image plane is changed by an angle 26 according to the above change.

Changing the tilt of the reflecting member 30 based on this principle allows the reflection surface thereof to be adjusted to match an intermediate position between the image plane position of the imaging optical system 20 and the object position of the re-imaging optical system 40. This allows the apparent image-plane position of the imaging optical system 20 to match the object position of the re-imaging optical system 40, so that the re-formed image of the sample can be formed on the imaging plane of the image sensor 50. For example, when the step imaging is performed, an image in which the entire sample is in focus can be acquired by performing the above-described focus adjustment.

A case has been described above with reference to FIGS. 2A and 2B, where the apparent image plane perpendicular to the optical axis X of the re-imaging optical system 40 is tilted with respect to the optical axis X of the re-imaging optical system 40. However, actually, unevenness on the surface of the sample causes the apparent image plane to be tilted with respect to the optical axis X of the re-imaging optical system 40 before the tilt of the reflecting member 30 is changed. Therefore, at the time of actual imaging, contrary to the above description with reference to FIGS. 2A and 2B, the tilt of the reflecting member 30 is adjusted so that the apparent image plane can be perpendicular to the optical axis X of the re-imaging optical system 40. Changing the tilt of the reflecting member 30 also changes the travelling direction of the light flux reflected on the reflection surface thereof. To accommodate this change, the numerical aperture (NA) of the re-imaging optical system 40 has only to be secured so that the light flux can fall within the optical path of the re-imaging optical system 40.

The objective optical system 500 according to the present exemplary embodiment is configured such that the reflecting member 30 is arranged on the optical path between the imaging optical system 20 and the re-imaging optical system 40, and the light flux caused to form an image by the imaging optical system 20 is reflected on the reflecting member 30 and the reflected light flux re-forms the image through the re-imaging optical system 40. If the re-imaging optical system 40 is a magnification system with a predetermined lateral magnification, the image of the sample formed by the imaging optical system 20 is enlarged at the lateral magnification and re-formed. If an object point is moved in the optical axis direction with respect to the re-imaging optical system 40, the amount of movement of the corresponding image point is enlarged according to longitudinal magnification (square of lateral magnification). For this reason, if the image-forming position of the imaging optical system 20 is changed by driving the reflecting member 30, the amount of displacement thereof is enlarged at the longitudinal magnification of the re-imaging optical system 40, so that the image re-forming position is changed by a larger amount of displacement. Using the magnification system as the re-imaging optical system 40 allows excellent focusing even if the amount of displacement of the reflecting member 30 is reduced.

As described above, if there is unevenness on the surface of the sample in the Z direction, the shape of the surface is changed depending on the XY position. Therefore, in order to perform excellent focus adjustment of the entire sample, the tilt direction and tilt amount of the reflecting member 30 need to be appropriately set according to the XY position of the surface of the sample. For example, if the step imaging is performed by moving the stage 100 in the horizontal direction to acquire an image of the entire sample, the tilt direction and tile amount of the reflecting member 30 need to be set for each step based on information about the shape of the sample.

However, if the surface of the sample in an area where the image sensor 50 can capture an image at one time (in an imaging area) is displaced in the optical axis direction of the imaging optical system 20, adjusting the tilt of the reflecting member 30 as described above causes a displacement of the position where the image of the sample is re-formed by the re-imaging optical system 40. More specifically, the image of the sample formed by the re-imaging optical system 40 is displaced in the direction perpendicular to the optical axis direction of the re-imaging optical system 40, further causing an image to be acquired to have a positional displacement in the in-plane direction. This makes it difficult to generate one image data by putting together the images of areas of the sample captured in a plurality of steps. If the position of the image of the sample is largely displaced, the image protrudes from the imaging plane of the image sensor 50, causing part of the image to be missing.

For this reason, the image acquisition apparatus 2000 according to the present exemplary embodiment is configured such that the positional displacement of the image in the in-plane direction caused by a change in the tilt of the reflecting member 30 can be corrected. Specifically, a driving unit for changing the position of the image sensor 50 in the direction perpendicular to the re-imaging optical system 40 is provided, and the driving unit and the calculation unit 400 are used as a correction unit. By controlling the driving direction and the driving amount of the image sensor 50 using the correction unit, when the tilt of the reflecting member 30 is changed for focus adjustment, the positional displacement of the image caused by the adjustment can be corrected. Accordingly, good image data in which the entire sample is in focus can be generated by putting together a plurality of pieces of image data acquired by capturing an image of each area of the sample. In the present exemplary embodiment, although the driving unit of the image sensor 50 and the calculation unit 400 are used as the correction unit, the present invention is not limited thereto. For example, there may be provided such a correction unit that adjusts the positions of the reflecting member 30 and the re-imaging optical system 40 simultaneously with the position of the image sensor 50 or that corrects the positional displacement of the image in the in-plane direction using image processing (to be described in detail below).

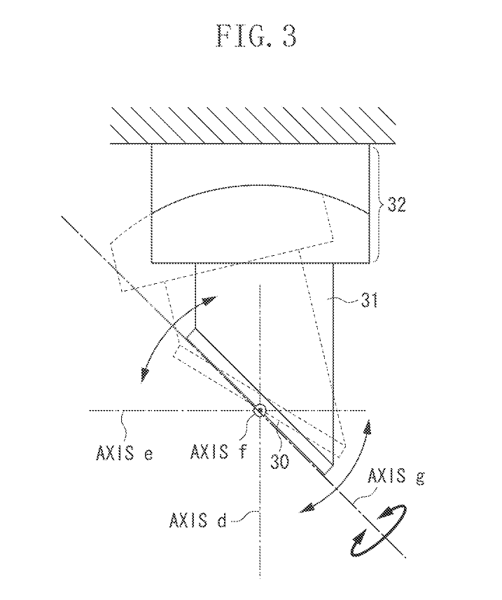

As illustrated in FIG. 3, a reflecting member driving unit for driving the reflecting member 30 (a first driving unit) includes a reflecting member holding unit 31 and a reflecting member tilt mechanism 32. The reflecting member 30 is attached to the reflecting member tilt mechanism 32 via the reflecting member holding unit 31. The reflecting member driving unit can adjust the tilt of the reflecting member 30 with an axis f, which is perpendicular to an axis d parallel to the optical axis of the imaging optical system 20 and an axis e parallel to the optical axis of the re-imaging optical system 40, as a rotational axis. Further, the reflecting member driving unit includes a mechanism (not illustrated) for adjusting the tilt of the reflecting member 30 with an axis g, which is perpendicular to the axis f and is parallel to the reflection surface of the reflecting member 30, as a rotational axis.

A swinging mechanism such as a gonio-stage illustrated in FIG. 3 or a rotational mechanism such as a rotation stage may be used as the reflecting member tilt mechanism 32. A slip plane, a bearing, or a leaf spring may be used as a sliding portion of the reflecting member tilt mechanism 32. A direct current (DC) motor, a pulse motor, a voice coil motor (VCM), or a piezo actuator may be used as an actuator for driving the reflecting member tilt mechanism 32.

As illustrated in FIG. 3, it is desirable to position the axes f and g on the reflection surface of the reflecting member 30. However, the present invention is not limited thereto. The axis f has only to be an axis that is perpendicular to the optical axis direction of the imaging optical system 20 (the direction along the optical axis) and the optical axis direction of the re-imaging optical system 40 (the direction along the optical axis), and the axis g has only to be an axis that is perpendicular to the direction of the axis f and is parallel to the reflection surface of the reflecting member 30.

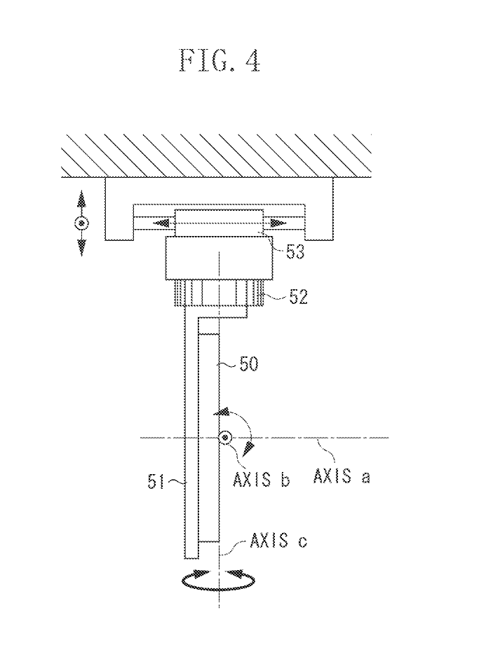

As illustrated in FIG. 4, an image sensor driving unit for driving the image sensor 50 (a second driving unit) includes an image sensor holding unit 51, an image sensor tilt mechanism 52, and an image sensor translation mechanism 53. The image sensor 50 is attached to the image sensor tilt mechanism 52 via the image sensor holding unit 51. The image sensor driving unit can adjust the tilt of the image sensor 50 with an axis c, which is parallel to the optical axis of the imaging optical system 20, as a rotational axis. Further, the image sensor driving unit also includes a mechanism (not illustrated) for adjusting the tilt of the image sensor 50 with an axis b, which is perpendicular to an axis c parallel to the optical axis of the imaging optical system 20 and an axis a parallel to the re-imaging optical system 40, as a rotational axis.

The image sensor tilt mechanism 52 is attached to the image sensor translation mechanism 53. The image sensor translation mechanism 53 can move the image sensor 50 in the optical axis direction of the re-imaging optical system 40 (in the direction of the axis a). Further, the image sensor driving unit also includes a mechanism (not illustrated) for adjusting the position of the image sensor 50 in the direction perpendicular to the optical axis direction of the re-imaging optical system 40 (the direction of the axes b and c).

As the image sensor tilt mechanism 52, a rotational mechanism such as a rotation stage illustrated in FIG. 4 or a swinging mechanism such as a gonio-stage may be used. As a sliding portion of the image sensor tilt mechanism 52, a slip plane, a bearing, or a leaf spring may be used. As an actuator for driving the image sensor tilt mechanism 52, a DC motor, a pulse motor, a VCM, or a piezo actuator may be used. As the image sensor translation mechanism 53, a linear motor, a stage using a linear guide, a linear ball screw and a DC motor, a pulse motor, a linear system driven by a VCM, and a mechanism using a leaf spring mechanism and a piezo actuator may be used.

As illustrated in FIG. 4, it is desirable for the axis c to be made parallel to the optical axis of the imaging optical system 20 and for the axis b to be made perpendicular to the axes a and c, so as to position the axes b and c on the image plane of the image sensor 50. However, the present invention is not limited thereto. The axis b has only to be an axis that is parallel to the axis f in driving the reflecting member 30, and the axis c has only to be an axis that is perpendicular to the direction of the axis b and is parallel to the imaging plane of the image sensor 50. If focus can be adjusted simply by driving the reflecting member 30, the image sensor driving unit only has to include only a mechanism for adjusting the position of the image sensor 50 in the direction perpendicular to the optical axis direction of the re-imaging optical system 40 (in the direction of the axes b and c).

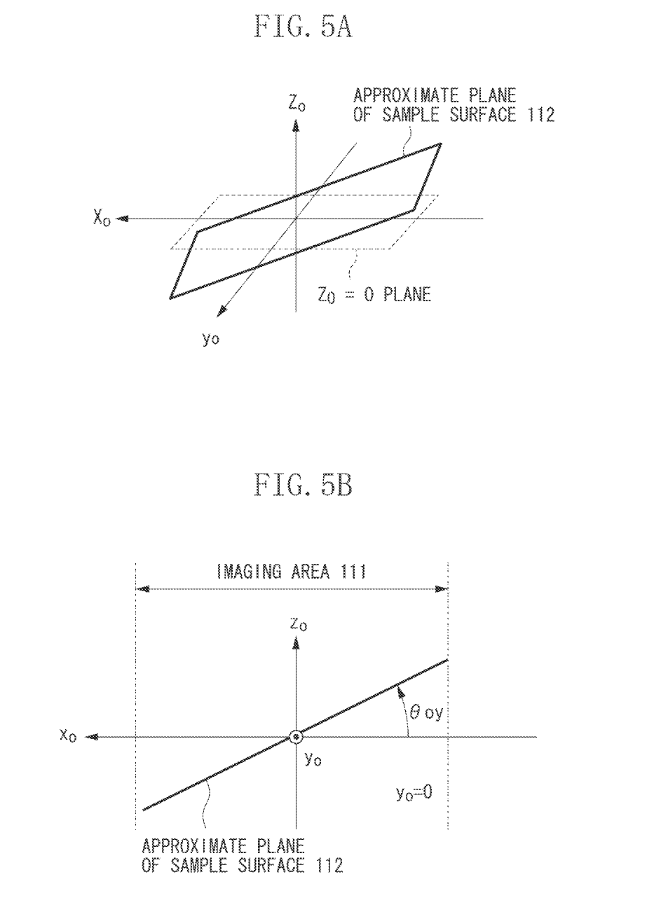

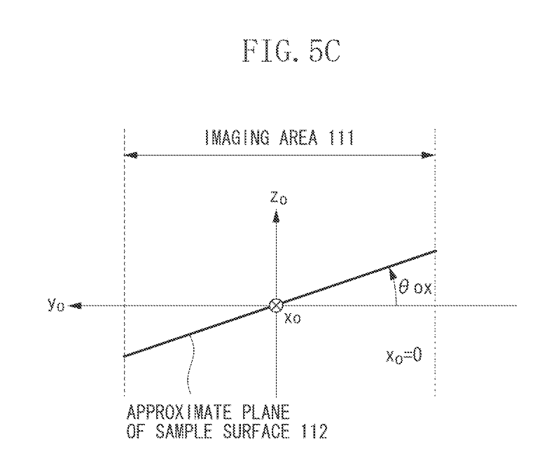

When focus is to be adjusted as described above, the calculation unit 400 first obtains an approximate plane of the surface of the sample for each area where the image sensor 50 can capture an image at one time (for each imaging area), based on information about the shape of the sample acquired by the measurement unit 200. FIGS. 5A, 5B, and 5C respectively illustrate an approximate plane 112 of the surface of the sample in an imaging area 111. Here, a coordinate system is defined such that an origin is an intersection of diagonal lines of the approximate plane 112, an axis z₀ is an axis parallel to the optical axis of the imaging optical system 20, an axis x₀ is an axis parallel to the optical axis of the re-imaging optical system 40, and an axis y₀ is an axis perpendicular to the axes z₀ and x₀. FIG. 5A illustrates the tilt of the approximate plane 112 with respect to the plane perpendicular to the axis z₀ (the z₀=0 plane). FIG. 5B illustrates the tilt θ_{oy} of the approximate plane 112 around the axis y₀ in the cross section of y₀=0. FIG. 5C illustrates the tilt θₒₓ of the approximate plane 112 around the axis x₀ in the cross section of x₀=0. At this point, the calculation unit 400 represents the approximate plane 112 of the surface of the sample using the following equation (1):

zₒ=(tan θ_{oy})×xₒ+(tan θₒₓ)×yₒ (1)

The calculation unit 400 controls the driving unit so that the amount of tilt θ_{my} around the axis f of the reflecting member 30 and the amount of tilt θₘₓ around the axis g thereof with respect to the approximate plane 112 represented by the equation (1) satisfy the following equations (2) and (3), where the magnification of the imaging optical system 20 is M₁.

θ_{my}=M₁θ_{oy}/2 (2)

θₘₓ=M₁θₒₓ/(√2) (3)

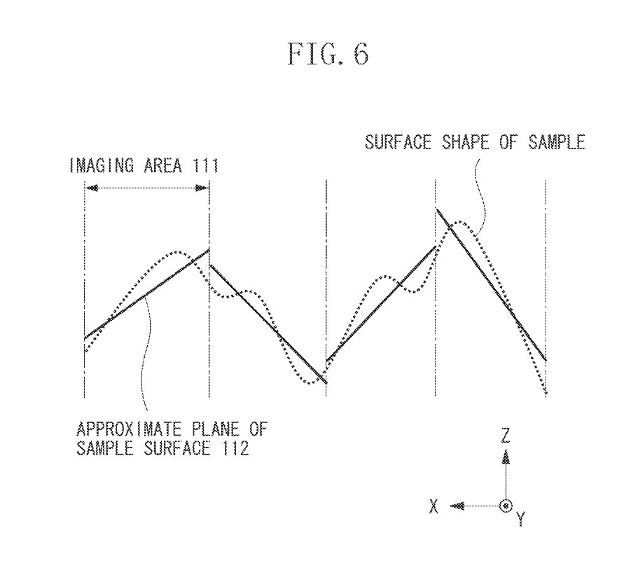

Thus, the calculation unit 400 controls the tilt of the reflecting member 30 according to the shape of the sample, so that an image in which the entire sample is in focus can be acquired. Further, the calculation unit 400 performs an approximate calculation using geometrical optics as described above, so that the amount of drive of the reflecting member 30 can be calculated at a high speed. If the sample is too large to capture an image thereof at one time and the step imaging needs to be performed, the approximate plane 112 of the surface of the sample has only to be acquired for each imaging area 111 corresponding to each step, as illustrated in FIG. 6.

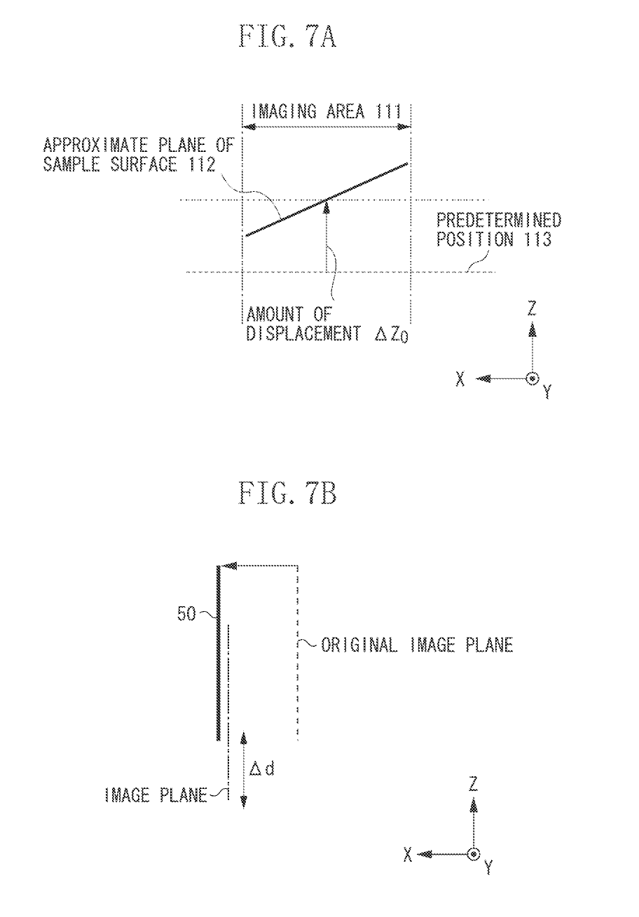

Here, as illustrated in FIG. 7A, a case will be discussed where the approximate plane 112 of the surface of the sample in the imaging area 111 is displaced by Δzₒ in the optical axis direction of the imaging optical system 20 (in the direction Z) with respect to a predetermined position 113. The predetermined position 113 refers to a position on an axis zₒ that is conjugate with the intersection of the reflection surface of the reflecting member 30 and the optical axis of the re-imaging optical system 40. At this point, the calculation unit 400 controls each driving unit so that the amount of movement Δzₘ of the reflecting member 30 in the optical axis direction of the imaging optical system 20 and the amount of movement Δx, of the image sensor 50 in the optical axis of the re-imaging optical system 40 satisfy the following equation (4), where the magnification of the re-imaging optical system 40 is M₂.

M₁²M₂²Δzₒ=M₂²Δzₘ+Δxₛ (4)

Thus, at least one of the reflecting member 30 and the image sensor 50 is moved to satisfy the equation (4), so that defocus (displacement of focal position) caused by the displacement of the approximate plane 112 of the surface of the sample in the optical axis direction of the imaging optical system 20 can be corrected. However, moving the reflecting member 30 in the optical axis direction of the imaging optical system 20 also causes a displacement of the position where the light flux is incident on the re-imaging optical system 40. It is therefore desirable to move the re-imaging optical system 40 in the optical axis direction of the imaging optical system 20 by the amount of movement equal to that of the reflecting member 30.

As illustrated in FIG. 7B, however, if the tilt of the reflecting member 30 is changed while the approximate plane 112 of the surface of the sample is displaced in the optical axis direction of the imaging optical system 20, the position where the image of the sample is formed by the re-imaging optical system 40 is displaced. More specifically, the image of the sample formed by the re-imaging optical system 40 is displaced in the direction (the directions Y and Z) perpendicular to the optical axis direction of the re-imaging optical system 40 (the direction X). This further causes an image to be acquired to have a positional displacement in the in-plane direction. Thus, the calculation unit 400 uses the following equation (5) to obtain the amount of movement Δd in the in-plane direction of the image of the sample formed by the re-imaging optical system 40 (the directions Y or Z), based on the amount of movement Δzₒ and the tilt θₒ (θₒₓ or θ_{oy}) of the approximate plane 112 of the surface of the sample:

Δd=M₁²M₂Δzₒ×sin(M₁θₒ) (5)

Then, the calculation unit 400 controls the image sensor driving unit based on the Δd to adjust the position of the image sensor 50 in the direction perpendicular to the re-imaging optical system 40, so that the positional displacement of the image in the in-plane direction caused by the change in the tilt of the reflecting member 30 can be corrected. The position of the image sensor 50 in the direction perpendicular to the re-imaging optical system 40 may be previously adjusted before the tilt of the reflecting member 30 is changed.

Here, in the image acquisition apparatus 2000, the reflecting member 30, the re-imaging optical system 40, and the image sensor 50 may be incorporated into one unit. In this case, a unit-driver for changing the position of the unit may be provided as the second driving unit. The calculation unit 400 and the unit-driver are taken as a correction unit, and the position of the unit in the direction perpendicular to the re-imaging optical system 40 may be adjusted based on the above-described Δd to correct the positional displacement of the image in the in-plane direction caused by the change in the tilt of the reflecting member 30. Such a configuration allows the amount of drive performed by the driving unit to be smaller than the configuration that adjusts only the position of the image sensor 50. Instead of adjusting the position of the image sensor 50 or the unit, the positional displacement of the image in the in-plane direction may be corrected by the image processing of the calculation unit 400.

As illustrated in FIG. 1, the image acquisition apparatus 2000 including a single reflecting member 30, a single re-imaging optical system 40, and a single image sensor 50 has been described. However, the present invention is not limited thereto. More specifically, the image acquisition apparatus 2000 may include a plurality of reflecting members 30, re-imaging optical systems 40, and image sensors 50. According to this configuration, the tilt of each of the plurality of reflecting members 30 and image sensors 50 is changed based on the information about the shape of the sample to perform adjustment so that the image re-forming position of each of the plurality of re-imaging optical systems 40 is on the imaging plane of each of the plurality of the corresponding image sensors 50. Therefore, focus can be adjusted in a larger number of areas at one time and images of a larger number of areas can be captured at one time. Further, the image acquisition apparatus 2000 uses such a configuration that a plurality of light fluxes from the imaging optical system 20 is deflected by a plurality of the reflecting members 30 in different directions, so that the plurality of image sensors 50 can be arranged to be dispersed in the planes different from each other. This provides a spatial allowance among the plurality of image sensors 50, enabling the image acquisition apparatus 2000 to be simplified because the driving unit, the temperature adjustment mechanism, and the like can be suitably arranged in each of the plurality of image sensors 50.

As described above, the image acquisition apparatus 2000 according to the present exemplary embodiment can perform focus adjustment by changing the tilt of the reflecting member 30 and can correct the positional displacement of the image in the in-plane direction caused by the change in the tilt of the reflecting member 30. This allows good image data in which the entire sample is in-focus to be acquired by using a simple configuration.

Exemplary embodiments of the image acquisition apparatus 2000 according to the present exemplary embodiment will be described below.

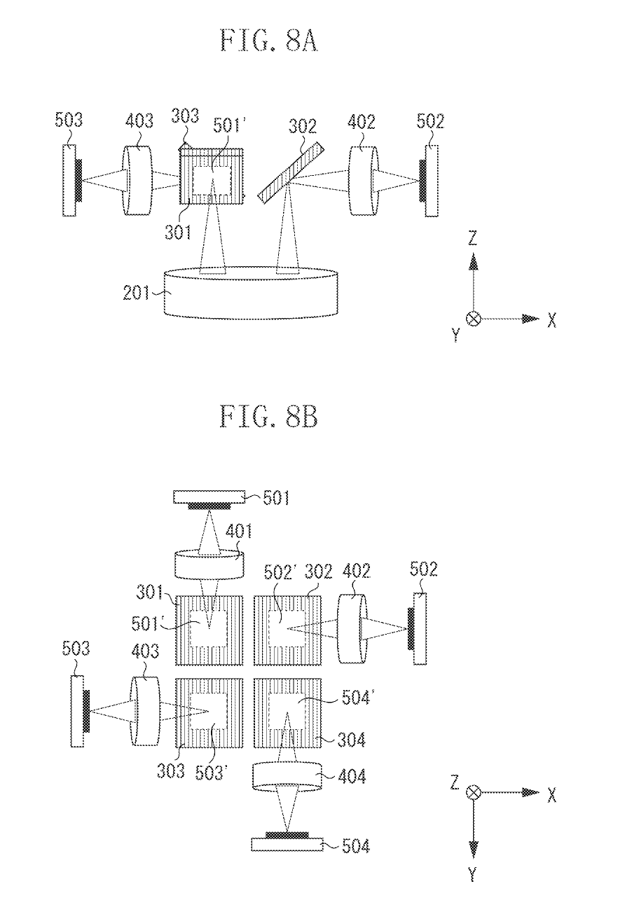

FIGS. 8A and 8B are schematic diagrams illustrating main portions of an objective optical system and its periphery included in an image acquisition apparatus 2000 according to a first exemplary embodiment of the present invention. FIG. 8A is a schematic diagram illustrating the objective optical system viewed in the plus Y direction. FIG. 8B is a schematic diagram illustrating the objective optical system viewed in the plus Z direction. The objective optical system according to the first exemplary embodiment includes an imaging optical system 201 (illustrating only a part of optical elements), reflecting members 301 to 304, and re-imaging optical systems 401 to 404. Areas 501′ to 504′ indicated by broken lines are the areas on the reflecting members 301 to 304 corresponding to the respective light receiving areas of image sensors 501 to 504. For the sake of convenience, parts of the reflecting member, the re-imaging optical system, and the image sensor are omitted in FIG. 8A and the tilt of each of the reflecting members and the imaging optical system are omitted in FIG. 8B.

As illustrated in the FIGS. 8A and 8B, the respective reflecting members 301 to 304 are arranged in a way to deflect the respective light fluxes from the imaging optical system 201 in different directions, and a plurality of the respective image sensors 501 to 504 is arranged to be dispersed in the planes different from each other. The corresponding re-imaging optical system 401 to 404 can cause the respective light fluxes reflected on the respective reflecting members 301 to 304 to re-form the images on the respective imaging planes of the corresponding image sensors 501 to 504. Such a configuration provides a spatial allowance among the image sensors 501 to 504, so that the driving unit, the temperature adjustment mechanism, and the like can be arranged more suitably in each of the image sensors 501 to 504.

An image-capturing operation by the image acquisition apparatus 2000 according to the first exemplary embodiment will be described in detail. The respective light fluxes from a sample in the preparation 110 pass through the imaging optical system 201 and form images of the sample near the respective reflecting members 301 to 304. The respective light fluxes forming the images of the sample are reflected on the respective reflecting members 301 to 304 and deflected outside the optical path of the imaging optical system 201. The respective deflected light fluxes are converged on the imaging planes of the respective image sensors 501 to 504 by the respective re-imaging optical systems 401 to 404. Thus, the image of the sample is re-formed on each of the imaging planes of the image sensors 501 to 504.

Focus is adjusted to cause the images of the sample re-formed by the respective re-imaging optical systems 401 to 404 to be entirely located on the imaging planes of the respective image sensors 501 to 504. Specifically, a driving unit (not illustrated) is controlled by a calculation unit based on information about the shape of the sample to change the tilts of the respective reflecting members 301 to 304. Further, the driving unit is controlled by the calculation unit to move the respective image sensors 501 to 504 in the direction perpendicular to the respective optical axes of the corresponding re-imaging optical systems 401 to 404. Thus, adjustment of the reflecting members 301 to 304 and the image sensors 501 to 504 can provide image data which is in focus in each of the image sensors 501 to 504 and whose positional displacement in the in-plane direction is corrected. If unevenness on the sample cannot be dealt with only by adjusting the tilts of the reflecting members 301 to 304, focus can be adjusted by driving the respective image sensors 501 to 504 in the respective optical axis directions of the corresponding re-imaging optical systems 401 to 404.

The image acquisition apparatus 2000 according to the first exemplary embodiment arranges a plurality of the image sensors 501 to 504, so that in-focus image data of a wider area can be acquired at one-time imaging. However, if areas whose image cannot be captured by the image sensors 501 to 504 at one time (gaps among the areas 501′ to 504′) occur, gaps also occur in image data to be acquired. In order to eliminate the areas whose image cannot be captured, in the present exemplary embodiment, a stage (not illustrated) holding a sample is moved in the XY direction to capture images step by step. At this point, the respective tilts of the reflecting members 301 to 304 are changed differently for each step based on information about the shape of the sample. Further, the respective positions of the corresponding image sensors 501 to 504 in the directions perpendicular to the respective optical axis directions of the corresponding re-imaging optical systems 401 to 404 are changed differently for each step based on the changes in the tilts of the respective reflecting members 301 to 304. The calculation unit 400 can put together pieces of image data acquired in each step, so that one image data in which the entire sample is in-focus without a gap can be generated.

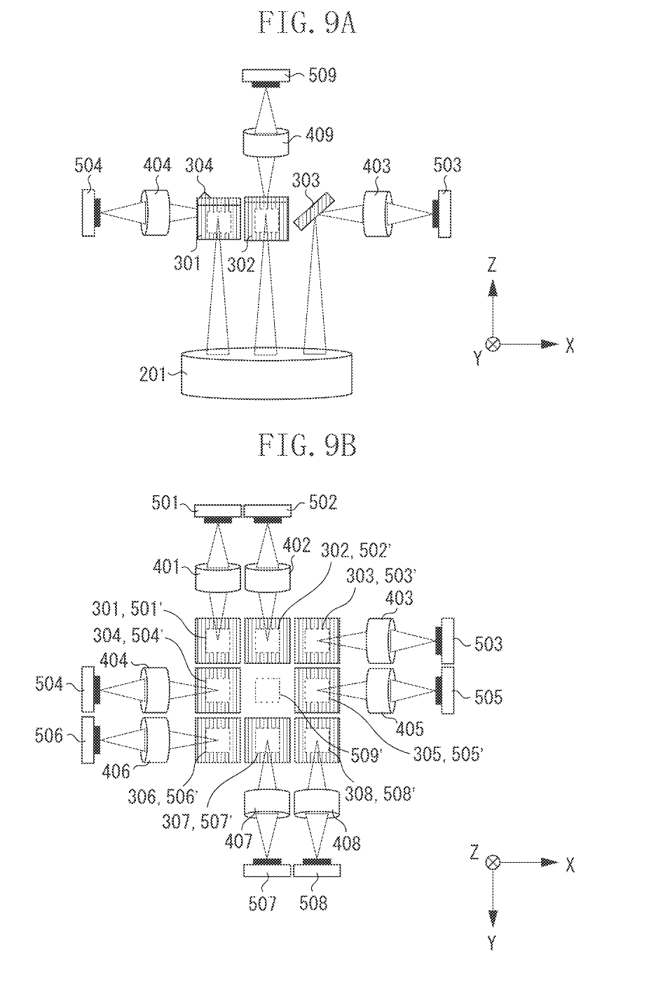

FIGS. 9A and 9B are schematic diagrams illustrating main portions of an objective optical system and its periphery included in an image acquisition apparatus according to a second exemplary embodiment of the present invention. FIG. 9A is a schematic diagram illustrating the objective optical system viewed in the plus Y direction. FIG. 9B is a schematic diagram illustrating the objective optical system viewed in the plus Z direction. The components similar or equivalent to those in the first exemplary embodiment are given the same reference numerals and the description thereof is omitted. The objective optical system according to the second exemplary embodiment includes an imaging optical system 201 (illustrating only a part of optical elements), reflecting members 301 to 308, and re-imaging optical systems 401 to 409, and forms an image on each of the image sensors 501 to 509. In other words, the numbers of reflecting members, re-imaging optical systems, and image sensors are larger than those in the first exemplary embodiment. An area 509′ indicates the area corresponding to the light receiving area of the image sensor 509 in an opening portion surrounded by the reflecting members 301 to 308.

As illustrated in FIGS. 9A and 9B, the respective reflecting members 301 to 308 are arranged in a way to deflect the respective light fluxes from the imaging optical system 201 in a plurality of directions, and a plurality of the respective image sensors 501 to 509 are arranged to be dispersed in a plurality of different planes. The corresponding respective re-imaging optical systems 401 to 408 can cause the respective light fluxes reflected on the respective reflecting members 301 to 308 to re-form the images on the respective imaging planes of the corresponding image sensors 501 to 508. Such a configuration provides a spatial allowance among the image sensors 501 to 509 so that the driving unit, the temperature adjustment mechanism, and the like can be arranged more suitably in each of the image sensors 501 to 509.

An image-capturing operation by the image acquisition apparatus 2000 according to the second exemplary embodiment will be described in detail. The respective light fluxes incident on the areas 501′ to 508′ among those from the sample in the preparation 110 pass through the imaging optical system 201 and form images of the sample near the respective reflecting members 301 to 308. Further, the light flux incident on the area 509′ among those from the sample forms an image of the sample near the opening surrounded by the reflecting members 301 to 308. At this point, the position of a stage (not illustrated) holding the sample in the optical axis direction and the tilt thereof with respect to the optical axis are adjusted so that the light flux incident on the area 509′ forms the image on the imaging plane of the image sensor 509. The optimum tilt of the stage is determined by, for example, a least-squares method based on the shape of the sample acquired by the measurement unit 200.

The stage is fixed in this position, and the tilts of the respective reflecting members 301 to 308 with respect to the optical axis of the imaging optical system 201 are adjusted based on information about the shape of the sample. This allows adjustment to be performed such that the images of the sample re-formed by the respective re-imaging optical systems 401 to 408 are entirely located on the imaging planes of the respective image sensors 501 to 508. Further, the respective positions of the image sensors 501 to 508 in the directions perpendicular to the respective optical axis directions of the corresponding re-imaging optical systems 401 to 408 are adjusted by the calculation unit and a driving unit (not illustrated). This allows image data which is in focus in each of the image sensors 501 to 508 and whose positional displacement in the in-plane direction is corrected.

The image acquisition apparatus 2000 according to the second exemplary embodiment arranges a plurality of the image sensors 501 to 509, so that in-focus image data of a wider area can be acquired at one-time imaging, as compared to the image acquisition apparatus 2000 according to the first exemplary embodiment. If there exists an area whose image cannot be captured at one time, as is the case with the first exemplary embodiment, image data of the entire sample can be acquired by moving the position of the stage holding the sample in the XY direction and capturing images step by step.

An image acquisition apparatus 2000 according to a third exemplary embodiment of the present invention is similar in the configuration of the objective optical system to that of the first exemplary embodiment illustrated in FIGS. 8A and 8B, but is different from that of the first exemplary embodiment in that the driving unit for moving each of the image sensors 501 to 504 is not provided.

In the third exemplary embodiment, as is the case with the first exemplary embodiment, the tilts of the respective reflecting members 301 to 304 with respect to the optical axis of the imaging optical system 201 are changed to adjust focus. However, the positional displacement of the image in the in-plane direction caused by the changes in the tilts of the respective reflecting members 301 to 304 is corrected by the image processing of image data, not by the control of driving the corresponding image sensors 501 to 504. Specifically, the calculation unit performs processing for correcting the position in the in-plane direction of the image data acquired by the respective image sensors 501 to 504 corresponding to the reflecting members 301 to 304. This processing allows acquisition of image data which in focus in each of the image sensors 501 to 504 and whose positional displacement in the in-plane direction is corrected.

In the third exemplary embodiment, if there exists an area whose image cannot be captured at one time, as is the case with the first exemplary embodiment, image data of the entire sample can be acquired by moving the position of the stage holding the sample in the XY direction and capturing images step by step.

As described above, the image acquisition apparatus 2000 according to the third exemplary embodiment can generate image data in which the entire sample is in focus, by adjusting the tilts of the reflecting members 301 to 304 and by correcting the positional displacement of the image data in the in-plane direction using the calculation unit. In this case, the driving unit for driving each of the image sensors 501 to 504 is not required, so that an electric circuit for reading data or a cooling mechanism (a temperature adjusting element) can be easily arranged in each of the image sensors 501 to 504.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In the above-described exemplary embodiments, for example, the imaging optical system and the re-imaging optical system are arranged so that the optical axes thereof are orthogonal to each other. However, the present invention is not limited thereto. Even if an angle made by the optical axes of the imaging optical system and the re-imaging optical system is not 90°, the above-described principle can be applied. The imaging optical system and the re-imaging optical system according to the above-described exemplary embodiments are the double telecentric optical system. However, the present invention is not limited thereto. Similarly, the rotational axes of the reflecting member and the image sensor are not limited to those described in the above-described exemplary embodiment, and other rotational axes may be employed.

Further, in the above-described exemplary embodiments, as illustrated in FIG. 4, the image sensor translation mechanism is provided for the image sensor. The similar translation mechanism may be provided for the reflecting member. This allows focus to be adjusted by driving at least one of the reflecting member and the image sensor in the optical axis direction of the corresponding re-imaging optical system, if unevenness on the sample cannot be dealt with only by adjusting the tilt of the reflecting member in each of the exemplary embodiments. If the step imaging is performed only by a single image sensor, focus adjustment may be performed by driving, for each step, the stage for holing the sample in the optical axis direction of the imaging optical system.

In the configuration including a plurality of image sensors, the number and arrangement of image sensors are appropriately determined according to the shape or size of the sample. Therefore, the re-imaging optical system and the reflecting member are arranged according to the arrangement of each of the image sensors, so that focus can be adjusted as is the case with each of the above-described exemplary embodiments. A configuration may be employed in which one image sensor for receiving a light flux without reflected by a reflecting member is provided, irrespective of the number of image sensors, as is the case with the second exemplary embodiment. In this case, the position where focus is adjusted on the imaging plane of the one image sensor is taken as a reference and then the tilts of the reflecting members corresponding to the other image sensors are adjusted so that focus can be adjusted in all of the image sensors.

In the first exemplary embodiment, the position of each of the image sensors is adjusted by using the driving unit and the calculation unit as a correction unit. However, the driving unit and the calculation unit of the unit including the corresponding reflecting member, re-imaging optical system, and image sensor may be used as a correction unit to adjust the position of the unit. In each of the above-described exemplary embodiments, the correction unit for adjusting the position of the image sensor or the unit and the correction unit for image processing may be combined. For example, in the configuration including a single image sensor, adjustment of the position of the image sensor or the unit and the image processing may be switched for each step. On the other hand, in the configuration including a plurality of image sensors, the correction may be performed by image processing without adjusting the position of a part of the image sensors or the unit (without providing the driving unit).

The configuration according to the second exemplary embodiment is such that the re-imaging optical system causes the light flux forming an image on the opening surrounded by each of the reflecting members to re-form the image on the imaging plane of one image sensor. However, a configuration for arranging the image sensor in the position of the opening may be used. Arranging the image sensor in the position of the opening allows an image to be formed on the imaging plane of the image sensor without a re-imaging optical system.

In each of the above-described exemplary embodiments, although the step imaging is performed in capturing an image of the entire sample, a configuration for scanning the entire sample can be applied to the exemplary embodiments of the present invention. Further, the image acquisition apparatus according to the exemplary embodiments of the present invention is useful not only as a microscope apparatus for magnifying and observing a sample by using the entire objective optical system as a magnification system, but also as an inspection apparatus for performing appearance inspection of a substrate and the like (inspection for adhesion of foreign matters, scratches and the like).

This application claims the benefit of Japanese Patent Application No. 2013-032104 filed Feb. 21, 2013, which is hereby incorporated by reference herein in its entirety.

What is claimed is:

1. An image acquisition apparatus comprising:
an imaging optical system configured to form an image of an object;
a re-imaging optical system configured to re-form the image of the object formed by the imaging optical system;
a reflecting member arranged on an optical path between the imaging optical system and the re-imaging optical system;
an image sensor configured to capture the image of the object re-formed by the re-imaging optical system to output image data;
a first driving unit configured to change a tilt of the reflecting member with respect to an optical axis of the imaging optical system;
a control unit configured to control the first driving unit according to a shape of the object; and
a correction unit configured to correct a positional displacement of the image in an in-plane direction according to the change in the tilt of the reflecting member.

2. The image acquisition apparatus according to claim 1, wherein the correction unit includes a second driving unit configured to move the image sensor in a direction perpendicular to an optical axis direction of the re-imaging optical system, and the control unit configured to control the second driving unit to correct the positional displacement of the image in the in-plane direction according to the change in the tilt of the reflecting member.

3. The image acquisition apparatus according to claim 1, wherein the correction unit includes a second driving unit configured to move the reflecting member, the re-imaging optical system, and the image sensor in the direction perpendicular to the optical axis direction of the re-imaging optical system, and the control unit configured to control the second driving unit to correct the positional displacement of the image in the in-plane direction according to the change in the tilt of the reflecting member.

4. The image acquisition apparatus according to claim 1, wherein the correction unit includes an image processing unit configured to process the image to correct the positional displacement of the image in the in-plane direction according to the change in the tilt of the reflecting member.

5. The image acquisition apparatus according to claim 1, wherein the correction unit corrects the positional displacement of the image in the in-plane direction based on the shape of the object.

6. The image acquisition apparatus according to claim 1, further comprising a measurement unit configured to acquire information about the shape of the object.

7. The image acquisition apparatus according to claim 1, wherein the re-imaging optical system is a magnification system.

8. The image acquisition apparatus according to claim 1, wherein the image acquisition apparatus is a microscope in which the imaging optical system and the re-imaging optical system form a magnification system.

9. The image acquisition apparatus according to claim 1, comprising a plurality of the re-imaging optical systems, the reflecting members, and the image sensors,
wherein each of the plurality of the re-imaging optical systems causes a light flux reflected by each of the corresponding plurality of the reflecting members to re-form the image of the object on each of imaging planes of the corresponding plurality of the image sensors.

10. An image acquisition system comprising:
an image acquisition apparatus including:
an imaging optical system configured to form an image of an object;
a re-imaging optical system configured
to re-form the image of the object formed by the imaging optical system;
a reflecting member arranged on an optical path between the imaging optical system and the re-imaging optical system;
an image sensor configured to capture the image of the object re-formed by the re-imaging optical system to output image data;
a first driving unit configured to change a tilt of the reflecting member with respect to an optical axis of the imaging optical system;
a control unit configured to control the first driving unit according to a shape of the object; and
a correction unit configured to correct a positional displacement of the image in an in-plane direction according to the change in the tilt of the reflecting member; and
an image display unit configured to display image data of the object acquired by the image acquisition apparatus.
